(19) United States
(12) Patent Application Publication
(10) Pub. No.: US 2006/0087863 A1
(43) Pub. Date: Apr. 27, 2006

(54) Optical lens system, backlight assembly and display device

(76) Inventors: Jin-Sung Choi, Yongin-si (KR); Jong-Dae Park, Seoul (KR); Dong-Hoon Kim, Seoul (KR)

Correspondence Address: CANTOR COLBURN, LLP, 55 GRIFFIN ROAD SOUTH, BLOOMFIELD, CT, 06002, US

(21) Appl. No.: 11/247,916

(22) Filed: Oct. 11, 2005

(30) Foreign Application Priority Data
Jan. 27, 2005 (KR) 2005-7574
Oct. 11, 2004 (KR) 2004-80993

(51) Int. Cl. G02B 6/00

(52) U.S. Cl. 362/551; 362/260

(57) ABSTRACT

An optical film includes liquid crystal layers and adhesive layers. The liquid crystal layers are disposed at a base substrate. Each of the liquid crystal layers reflects light having a first wavelength and transmits light having a wavelength different from the first wavelength. Each of the adhesive layers is disposed between adjacent ones of the liquid crystal layers to combine the liquid crystal layers.

### CROSS REFERENCE TO RELATED APPLICATIONS

This application claims priority to Korean Patent Application No. 2004-80993 filed on Oct. 11, 2004 and all the benefits accruing therefrom under 35 U.S.C §119, and the contents of which in its entirety are herein incorporated by reference.

### BACKGROUND OF THE INVENTION

1. Field of the Invention

The present invention relates to an optical film, a method of manufacturing the optical film, and a flat fluorescent lamp and a display device having the optical film. More particularly, the present invention relates to an optical film having a reflective polarizing function, a method of manufacturing the optical film, and a flat fluorescent lamp and a display device having the optical film.

2. Description of the Related Art

Recently, liquid crystal display (LCD) devices have been manufactured to employ a flat fluorescent lamp instead of a cold cathode fluorescent lamp (CCFL). The flat fluorescent lamp has been employed to reduce a manufacturing cost of LCD display devices. Furthermore, the flat fluorescent lamp has better optical and electrical properties than the CCFL.

The flat fluorescent lamp includes mercury (Hg), and may further include argon (Ar) for generating light. When the flat fluorescent lamp generates light using mercury (Hg), mercury adheres at a portion of an inner surface of a flat fluorescent lamp body where an electrode part is formed, which may blacken the portion of the inner surface of the flat fluorescent lamp body.

Conventional LCD devices having a relatively large size employed the CCFL, but were replaced by an external electrode fluorescent lamp (EEFL) in order to reduce the manufacturing cost. Using the flat fluorescent lamp further lowered the manufacturing cost of the conventional LCD devices.

However, the flat fluorescent lamp still has problems. For example, the flat fluorescent lamp has a relatively low light using efficiency and a relatively low luminance uniformity due to a presence of such features as a partition member, a furrow formed on a substrate, an electrode, etc. When the partition member or the furrow is not employed in the flat fluorescent lamp in order to reduce above-mentioned problems, other problems such as channeling occur.

In order to enhance the luminance uniformity, various optical films are disposed on the flat fluorescent lamp, which increase manufacturing costs. Thus it is desirable to develop an optical film, which inexpensively solves the above-mentioned problems.

### SUMMARY OF THE INVENTION

The present invention provides an optical film capable of reflectively polarizing light. The present invention also provides a method of manufacturing the optical film mentioned above. The present invention also provides a flat fluorescent lamp having the optical film integrally formed therewith. The present invention also provides a display device having the flat fluorescent lamp mentioned above.

In an exemplary optical film according to the present invention, the optical film includes liquid crystal layers and adhesive layers. The liquid crystal layers are disposed at a base substrate. Each of the liquid crystal layers reflects light having a first wavelength and transmits light having a wavelength different from the first wavelength. Each of the adhesive layers is disposed between adjacent ones of the liquid crystal layers to combine the liquid crystal layers.

In an exemplary method of manufacturing an optical film according to the present invention, a first liquid crystal layer including a cholesteric liquid crystal and a vertical alignment (VA) liquid crystal mixed in a first ratio is disposed at a base substrate. The first liquid crystal layer reflects light having a first wavelength and transmits light having a wavelength different from the first wavelength. A second liquid crystal layer is disposed at the first liquid crystal layer. The second liquid crystal layer includes the cholesteric liquid crystal and the VA liquid crystal mixed in a second ratio. The second liquid crystal layer reflects light having a second wavelength and transmits light having a wavelength different from the second wavelength. A third liquid crystal layer is disposed at the second liquid crystal layer. The third liquid crystal layer includes the cholesteric liquid crystal and the VA liquid crystal mixed in a third ratio. The third liquid crystal layer reflects light having a third wavelength and transmits light having a wavelength different from the third wavelength. A phase shift layer is disposed at the third liquid crystal layer.

In an exemplary flat fluorescent lamp according to the present invention, the flat fluorescent lamp includes a lamp body, electrodes, and a reflective polarizing layer. The lamp body includes discharge spaces arranged parallel to each other and extended along a first direction. The electrodes are disposed at opposite ends of an outer surface of the lamp body. Each of the electrodes is extended along a second direction that is substantially perpendicular to the first direction. The reflective polarizing layer is disposed at the lamp body. The reflective polarizing layer reflects a first portion of light generated by the lamp body and transmits a second portion of light generated by the lamp body.

In another exemplary flat fluorescent lamp according to the present invention, the flat fluorescent lamp includes a lamp body and external electrodes. The lamp body includes discharge spaces arranged in parallel with each other and extended along a first direction. The lamp body emits light generated by discharge gas disposed in the discharge spaces through a light-exiting surface of the lamp body. The light-exiting surface includes a light-diffusing material in order to diffuse light. The external electrodes are disposed at an outer surface of the lamp body and extended along a second direction that is substantially perpendicular to the first direction.

In an exemplary display device according to the present invention, the display device includes a flat fluorescent lamp and a display panel. The flat fluorescent lamp includes a lamp body, first electrodes and a reflective polarizing layer. The lamp body includes discharge spaces arranged parallel to each other and extended along a first direction. The first electrodes are disposed at opposite ends of a first outer surface of the lamp body. The first electrodes are extended along a second direction that is substantially perpendicular to the first direction. The reflective polarizing layer is disposed at the lamp body. The reflective polarizing layer reflects a first portion of light generated from the lamp body and transmits a second portion of light generated from the lamp body. The display panel displays images using the second portion of light.

Therefore, luminance uniformity is enhanced. Furthermore, functions of a light-diffusing plate, a reflective polarizing film and a prism sheet are integrated into a reflective polarizing layer. Therefore, productivity is enhanced.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is an exploded perspective view illustrating a flat fluorescent lamp according to an exemplary embodiment of the present invention;

FIG. 2 is a cross-sectional view illustrating the flat fluorescent lamp in FIG. 1;

FIG. 3 is a schematic cross-sectional view illustrating a reflective polarizing film having cholesteric liquid crystal;

FIGS. 4A and 4B are conceptual views illustrating the cholesteric liquid crystal in FIG. 3;

FIG. 5 is a diagram illustrating a principle of reflective polarization of a cholesteric liquid crystal;

FIG. 6 is a conceptual view illustrating reflective polarization steps performed by a dual brightness enhancement film (DBEF) film and the reflective polarizing film having cholesteric liquid crystal;

FIG. 7 is an exploded perspective view illustrating a flat fluorescent lamp according to another exemplary embodiment of the present invention;

FIG. 8 is an exploded perspective view illustrating a flat fluorescent lamp according to still another exemplary embodiment of the present invention;

FIG. 9 is a cross-sectional view illustrating the flat fluorescent lamp in FIG. 8;

FIGS. 10A and 10B are conceptual views illustrating polarization steps of a first light that enters a reflective polarizing film having cholesteric liquid crystal at an angle substantially perpendicular to a planar surface of a flat fluorescent lamp and a second light that enters the reflective polarizing film having cholesteric liquid crystal in at an angle inclined with respect to a planar surface of a flat fluorescent lamp;

FIG. 11 is an exploded perspective view illustrating a flat fluorescent lamp according to still another exemplary embodiment of the present invention;

FIG. 12 is a cross-sectional view illustrating a method of manufacturing a reflective polarizing film;

FIGS. 13A and 13B are conceptual views illustrating an ultraviolet (UV) photopolymerization mechanism;

FIG. 14 is an exploded perspective view illustrating a flat fluorescent lamp according to still another exemplary embodiment of the present invention;

FIG. 15 is a schematic view illustrating a method of manufacturing a flat fluorescent lamp having a reflective polarizing film integrally formed therewith; and

FIG. 16 is an exploded perspective view illustrating a liquid crystal display device according to an exemplary embodiment of the present invention.

### DETAILED DESCRIPTION OF THE INVENTION

It should be understood that the exemplary embodiments of the present invention described below may be varied or modified in many different ways without departing from the inventive principles disclosed herein, and the scope of the present invention is therefore not limited to these particular flowing embodiments. Rather, these embodiments are provided so that this disclosure will be thorough and complete, and will fully convey the concept of the invention to those skilled in the art by way of example and not of limitation.

Hereinafter, exemplary embodiments of the present invention will be described in detail with reference to the accompanied drawings.

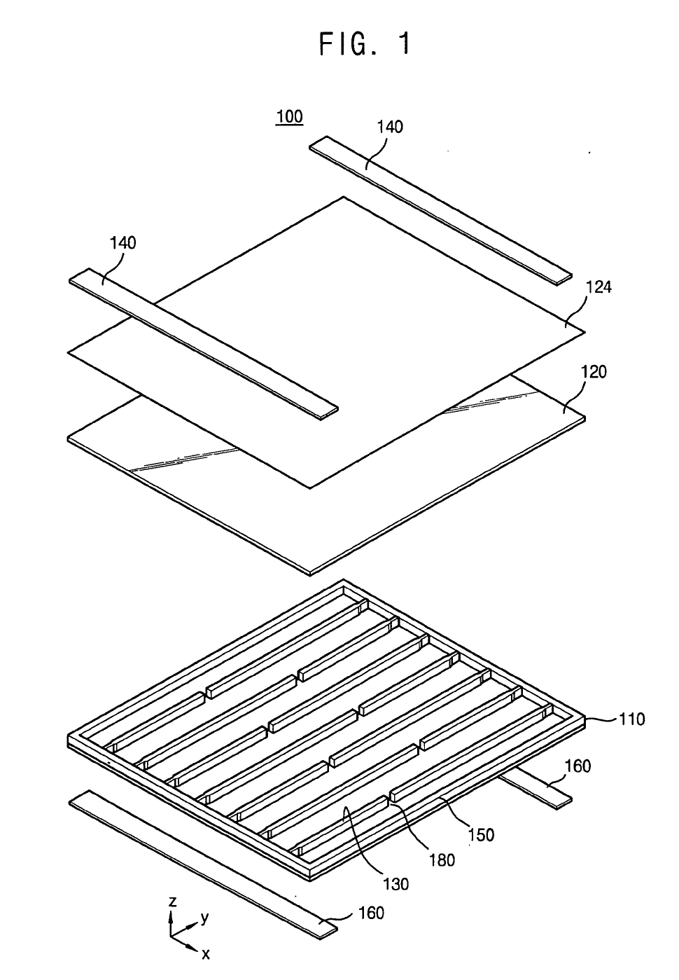

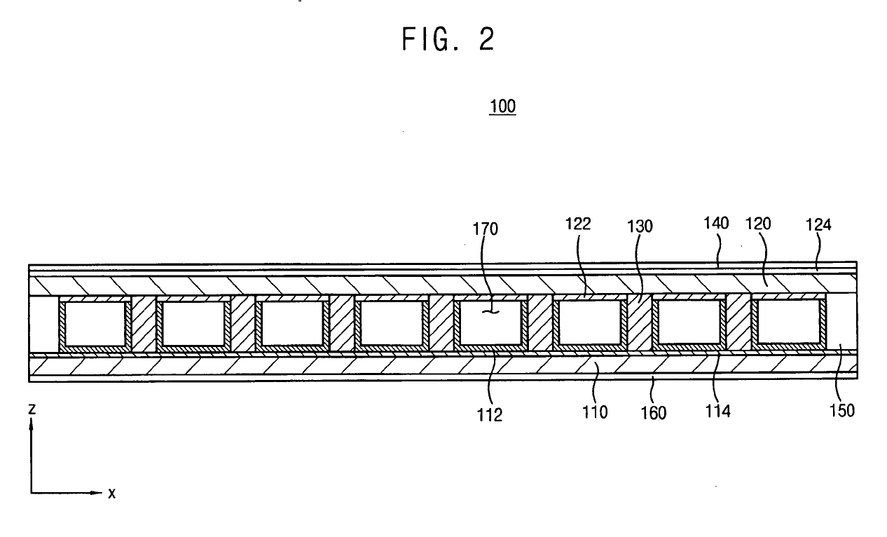

FIG. 1 is an exploded perspective view illustrating a flat fluorescent lamp according to an exemplary embodiment of the present invention, and FIG. 2 is a cross-sectional view illustrating the flat fluorescent lamp in FIG. 1. The flat fluorescent lamp in FIGS. 1 and 2 has a partition member formed through a nozzle method and a light-diffusing layer having a cholesteric liquid crystal.

Referring to FIGS. 1 and 2, a flat fluorescent lamp 100 according to the present embodiment includes a rear substrate 110, a front substrate 120, partition members 130 disposed at the rear substrate 110 and first external electrodes 140.

The rear and front substrates 110 and 120 include a glass substrate that blocks ultraviolet light and transmits visible light. The flat fluorescent lamp 100 further includes a reflective polarizing layer 124 disposed at the front substrate 120. The reflective polarizing layer 124 reflects a portion of light that exits the front substrate 120, and linearly polarizes a remaining portion of the light.

The reflective polarizing layer 124 includes a cholesteric liquid crystal layer and a phase shifting layer. The cholesteric liquid crystal layer is disposed at a surface of the front substrate 120, which faces away from the rear substrate 110, and the phase shifting layer is disposed at a surface of the cholesteric liquid crystal layer that faces away from the front substrate 120. Liquid crystal molecules having a bar shape are arranged in a spiral shape in the cholesteric liquid crystal layer. In other words, the liquid crystal molecules having the bar shape and arranged parallel to each other in a virtual xy-plane. Each adjacent liquid crystal molecule is disposed at a position rotated gradually with respect to each other about an axis extended along a z-direction. The z-direction extends substantially perpendicular to the virtual xy-plane. The cholesteric liquid crystal layer having a structure described above is referred as a chiral liquid nematic crystal. The cholesteric liquid crystal layer reflects light having a wavelength that is substantially equal to a spiral pitch, which corresponds to a distance between certain liquid crystal molecules along the z-direction, times an average refractivity of an extraordinary refractivity and an ordinary refractivity of a cholesteric liquid crystal. The cholesteric liquid crystal layer transmits light having a wavelength that is different than the spiral pitch. The phase shift layer disposed at the cholesteric liquid crystal layer polarizes light that passes through the cholesteric liquid crystal layer.

The rear and front substrates 110 and 120 are combined with each other by a sealing member 150. The sealing member 150 is disposed along edge portions of the rear and front substrates 110 and 120 to define an inner space between the rear and front substrates 110 and 120 surrounded by the sealing member 150.

The partition members 130 are disposed at the inner space between the rear and front substrates 110 and 120. The partition members 130 are arranged parallel to each other to divide the inner space into discharge spaces 170. The partition members 130 are spaced apart from each other by substantially a same distance.

Each of the partition members 130 includes a connection path 180 for connecting adjacent discharge spaces 170 to each other. Each of the partition members 130 is broken into two pieces spaced apart from each other to form the connection path 180. Alternatively, each of the partition members 130 may have a through hole connecting adjacent discharge spaces 170 to each other. The through hole corresponds to the connection path 180. The connection path 180 may be disposed at an arbitrary position along the partition members 130. Preferably, each connection path 180 is disposed such that connection paths 180 of the partition members 130 are not disposed in a line. For example, the connection paths 180 of the partition members 130 are arranged in a zigzag shape.

Discharge gas injected into one of the discharge spaces 170 spreads throughout the discharge spaces 170 via the connection paths 180 to be uniformly distributed. Each of the partition members 130 may include more than one connection path 180.

The first external electrodes 140 are disposed at an outer surface of the reflective polarizing layer 124. Each of the first external electrodes 140 is disposed at first and second end portions of the reflective polarizing layer 124, respectively. The first external electrodes 140 are disposed such that a longitudinal direction of the first external electrodes 140 is substantially perpendicular to a longitudinal direction of the partition members 130.

The flat fluorescent lamp 100 may further include second external electrodes 160. The second external electrodes 160 are disposed at an outer surface of a rear substrate 110 such that each of the first external electrodes 140 corresponds to each of the second external electrodes 160, respectively.

The flat fluorescent lamp 100 further includes a first fluorescent layer 112 and a second fluorescent layer 122. The first fluorescent layer 112 is disposed at an inner surface of the rear substrate 110. The first fluorescent layer 112 may optionally be disposed at a side surface of each of the partition members 130. The second fluorescent layer 122 is disposed at an inner surface of the front substrate 120. Thus, in an exemplary embodiment, each of the discharge spaces 170 is surrounded by the first and second fluorescent layers 112 and 122. The first and second fluorescent layers 112 and 122 convert ultraviolet light generated by plasma discharge into visible light. A light-reflecting layer 114 is disposed between the rear substrate 110 and the first fluorescent layer 112. The light-reflecting layer 114 reflects the visible light toward the front substrate 120 to prevent light leakage.

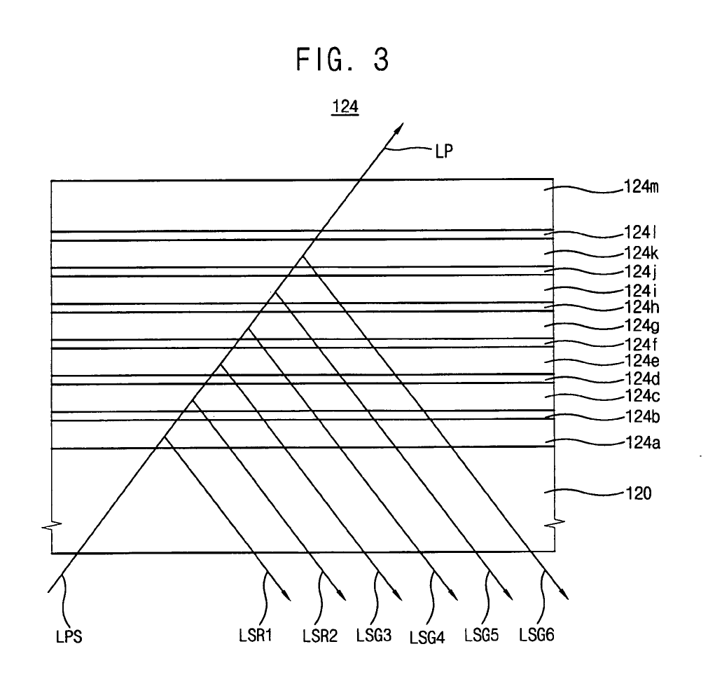

FIG. 3 is a schematic cross-sectional view illustrating a reflective polarizing film having cholesteric liquid crystal.

Referring to FIGS. 1 and 3, the reflective polarizing film 124 according to an exemplary embodiment of the present invention has a multi-layered structure. The reflective polarizing film 124 produces a linearly polarized light LP responsive to a light LPS. The reflective polarizing film 124 includes first through sixth cholesteric liquid crystal layers 124a, 124c, 124e, 124g, 124i and 124k, first through sixth adhesive layers 124b, 124d, 124f, 124h, 124j and 124l, and a phase shift layer 124m. The first through sixth cholesteric liquid crystal layers 124a, 124c, 124e, 124g, 124i and 124k reflect light having a wavelength that is substantially equal to a spiral pitch times an average refractivity of an extraordinary refractivity nₑ and an ordinary refractivity no of a cholesteric liquid crystal, and transmit light having a different wavelength.

The first through sixth adhesive layers 124b, 124d, 124f, 124h, 124j and 124l are alternately disposed between the first through sixth cholesteric liquid crystal layers 124a, 124c, 124e, 124g, 124i and 124k. For example, the first adhesive layer 124b is disposed between the first and second cholesteric liquid crystal layers 124a and 124c. The second adhesive layer 124d is disposed between the second and third cholesteric liquid crystal layers 124c and 124e. The third adhesive layer 124f is disposed between the third and fourth cholesteric liquid crystal layers 124e and 124g. The fourth adhesive layer 124h is disposed between the fourth and fifth cholesteric liquid crystal layers 124g and 124i. The fifth adhesive layer 124j is disposed between the fifth and sixth cholesteric liquid crystal layers 124i and 124k. The sixth adhesive layer 124l is disposed between the sixth cholesteric liquid crystal layer 124k and the phase shift layer 124m.

The first cholesteric liquid crystal layer 124a reflects a first light LSR1 having a first wavelength, and transmits light having a wavelength different from the first wavelength. The second cholesteric liquid crystal layer 124c reflects a second light LSR2 having a second wavelength, and transmits light having a wavelength different from the second wavelength. The third cholesteric liquid crystal layer 124e reflects a third light LSR3 having a third wavelength, and transmits light having a wavelength different from the third wavelength. The fourth cholesteric liquid crystal layer 124g reflects a fourth light LSR4 having a fourth wavelength, and transmits light having a wavelength different from the fourth wavelength. The fifth cholesteric liquid crystal layer 124i reflects a fifth light LSR5 having a fifth wavelength, and transmits light having a wavelength different from the fifth wavelength. The sixth cholesteric liquid crystal layer 124k reflects a sixth light LSR6 having a sixth wavelength, and transmits light having a wavelength different from the sixth wavelength.

The first wavelength is a maximum wavelength value, and the sixth wavelength is a minimum wavelength value. Thus, wavelengths decrease from the first wavelength to the sixth wavelength. For example, the first and second lights LSR1 and LSR2 correspond to a red colored light. The third and fourth lights LSR3 and LSR4 correspond to a green colored light. The fifth and sixth lights LSR5 and LSR6 correspond to a blue colored light. The first through sixth cholesteric liquid crystal layers 124a through 124k that reflect light having a corresponding specific wavelength may be formed by adjusting an amount of cholesteric liquid crystal and an amount of vertical alignment (VA) liquid crystal in a particular film layer of the reflective polarizing film 124.

A thickness of each of the first through sixth cholesteric liquid crystal layers 124a through 124k is greater than a thickness of each of the first through sixth adhesive layers 124b through 124l. A ratio of the thickness of each of the first through sixth cholesteric liquid crystal layers 124a through 124k to the thickness of each of the first through sixth adhesive layers 124b through 124l is in a range from about 4.5:1 to about 3.5:2.

Additionally, a thickness of the phase shift layer 124m is about 2.5 times thicker than the thickness of the sixth cholesteric liquid crystal layer 124k. For example, when the thickness of the sixth cholesteric liquid crystal layer 124k is about 20 μm, the thickness of the phase shift layer 124m is about 50 μm.

Hereinbefore, the reflective polarizing layer 124 is directly formed, for example, on a glass substrate such as, for example, the front substrate 120. Alternatively, the reflective polarizing layer 124 may be formed on a base substrate such as, for example, a polyester filament film (PEF) to form a reflective polarizing film, and the reflective polarizing film may be disposed at the front substrate 120.

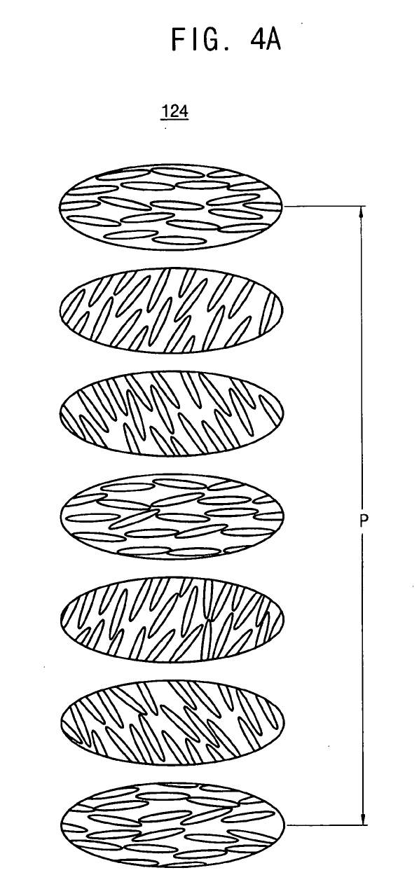

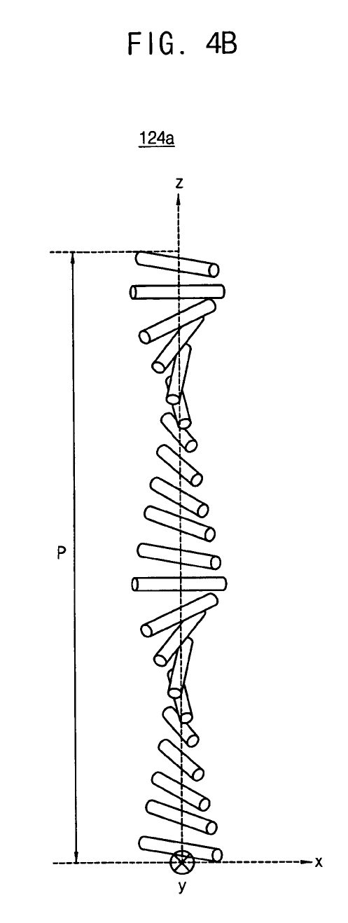

FIGS. 4A and 4B are conceptual views illustrating the cholesteric liquid crystal in FIG. 3. FIG. 4A illustrates a structure of cholesteric liquid crystal molecules, and FIG. 4B illustrates a spiral axis and the spiral pitch.

Referring to FIG. 4A, an alignment of cholesteric liquid crystal molecules is such that adjacent liquid crystal molecules are located at a position rotated gradually with respect to each other about a spiral axis. A spiral structure and period ‘p’ are special features of cholesteric liquid crystal. The spiral axis corresponds to an optical axis, which is substantially parallel to the z-direction.

When a portion of liquid crystal molecules in nematic phase breaks mirror symmetry, the portion of liquid crystal molecules has the spiral structure. The portion of liquid crystal molecules having the spiral structure is referred to as cholesteric liquid crystal (CLC). Locally, directors of the cholesteric liquid crystal molecules have a same direction, but globally, the directors rotate gradually with respect to the spiral axis.

Referring to FIG. 4B, cholesteric liquid crystal molecules are positioned rotated gradually about the spiral axis such that specific cholesteric liquid crystal molecules spaced apart by a given interval have a same orientation with respect to the spiral axis. A distance between a first specific cholesteric liquid crystal molecule and a second specific cholesteric liquid crystal molecule having a same orientation with respect to the spiral axis is referred to as spiral pitch ‘P’. The cholesteric liquid crystal induces Bragg reflection due to a repetitive characteristic of the spiral structure. When cholesteric liquid crystal molecules are arranged such that the spiral axis is substantially perpendicular to a surface of the base substrate, light having a wavelength that is substantially equal to the spiral pitch “P” times an average refractivity of an extraordinary refractivity nₑ and an ordinary refractivity no of a cholesteric liquid crystal is reflected, and a light having a different wavelength is transmitted.

The wavelength A of light that is reflected is represented by the following expression 1.
λ=×nₐ, Expression 1

wherein nₐ represents a average refractivity of the cholesteric liquid crystal layer. The average refractivity nₐ is represented as the following Expression 2.
nₐ=(nₒ+nₑ)/2, Expression 2

wherein nₒ corresponds to an ordinary refractivity of cholesteric liquid crystal, and nₑ corresponds to an extraordinary refractivity of cholesteric liquid crystal.

When a thickness the cholesteric liquid crystal layer has a predetermined value, the cholesteric liquid crystal layer has a reflectivity of about 50%, and a transmissivity of about 50%. Typically, when a thickness of the cholesteric liquid crystal layer is about ten times greater than the spiral pitch ‘P’, the reflectivity of about 50% is obtained. Light reflected by the cholesteric liquid crystal layer may be right-handed circularly polarized or left-handed circularly polarized according to a direction of rotation (or chirality) of the cholesteric liquid crystal molecules about the spiral axis. For example, when the cholesteric liquid crystal molecules are rotated along a right-handed direction, the reflected light is right-handed circularly polarized. On the contrary, when the cholesteric liquid crystal molecules are rotated along a left-handed direction, the reflected light is left-handed circularly polarized. However, light that is transmitted has an opposite polarization to light that is reflected.

By using the cholesteric liquid crystal, a circular polarizer that circularly polarizes light having a specific wavelength may be formed. Furthermore, when a bandwidth of the reflected light is wide enough to cover wavelengths of visible light, the circular polarizer may circularly polarize a white light having all possible wavelengths corresponding to visible light. The cholesteric liquid crystal reflects light. Therefore, when the reflected light is further reflected toward the cholesteric liquid crystal, a light-efficiency may be enhanced.

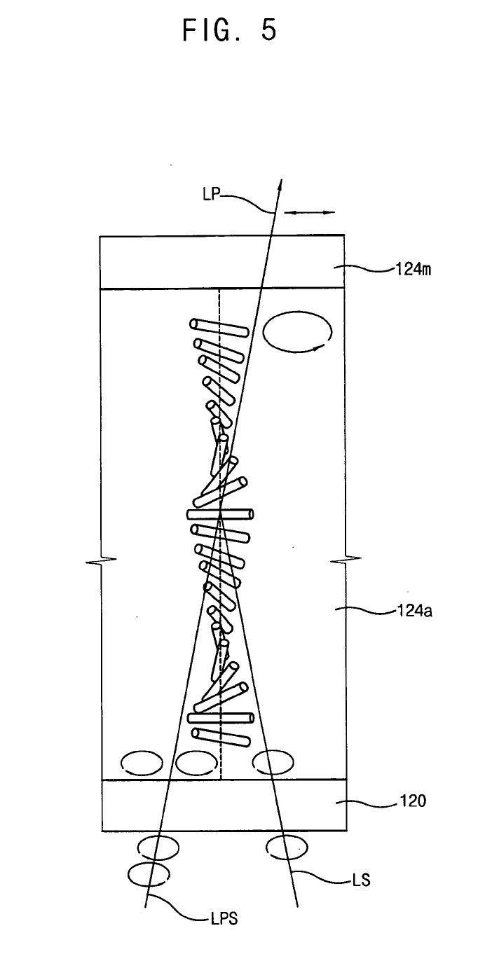

FIG. 5 is a diagram illustrating a principle of reflective polarization of a cholesteric liquid crystal.

Referring to FIG. 5, the first cholesteric liquid crystal layer 124a is disposed at the front substrate 120. The first cholesteric liquid crystal layer 124a includes cholesteric liquid crystal molecules that are right-handed circularly polarized. When light LPS having both right-handed circularly polarized light and left-handed circularly polarized light enters the first cholesteric liquid crystal layer 124a, the right-handed circularly polarized light is reflected by the first cholesteric liquid crystal layer 124a and the left-handed circularly polarized light is transmitted. The right-handed circularly polarized light that is reflected LS by the first cholesteric liquid crystal layer 124a is reused to enhance light-using efficiency. The left-handed circularly polarized light that is transmitted is converted into a linearly polarized light LP by the phase shift layer 124m.

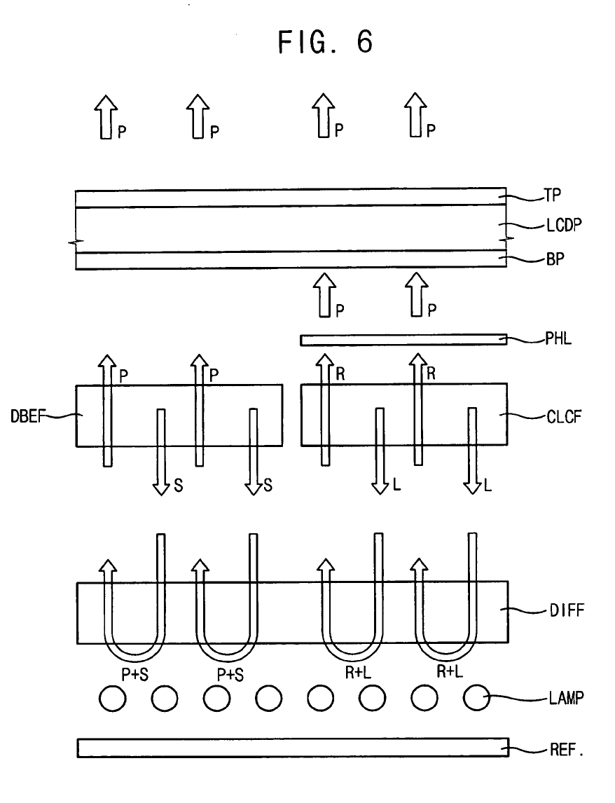

FIG. 6 is a conceptual view illustrating reflective polarization steps performed by a conventional dual brightness enhancement film (DBEF) film and a reflective polarizing film having cholesteric liquid crystal.

Referring to FIG. 6, a conventional DBEF that corresponds to a conventional reflective polarizing film has a multi-layered structure. For example, the conventional DBEF film includes a plurality of anisotropic films and a plurality of isotropic films. The anisotropic film is stretched along, for example, the x-direction, so that an x-directional refractivity nₓ is different from a y-directional refractivity n_{y} and a z-directional refractivity n_{z} (nₓ>n_{y}=n_{z}). Alternatively, the x-directional refractivity nₓ, the y-directional refractivity n_{y} and the z-directional refractivity n_{z} of the isotropic film are substantially same as each other (nₓ=n_{y}=n_{z}).

When a multi-layered film is not stretched, a refractivity nₓ(A) of an A-material is substantially same as a refractivity nₓ(Y) of a Y-material, so that the multi-layered film does not reflectively polarize light. However, when the multi-layered film is stretched, the refractivity nₓ(A) of the A-material is raised to be greater than the refractivity nₓ(Y) of the Y-material, so that the multi-layered film transmits a P-polarized light and reflects an S-polarized light. The S-polarized light that is reflected is reused to raise an amount of the P-polarized light.

The conventional DBEF film transmits the P-polarized light generated by a backlight assembly including a lamp LAMP, a light-reflecting plate REF and a diffusion plate DIFF to apply the P-polarized light to a display unit, and reflects the S-polarized light generated by the backlight assembly so that the reflected S-polarized light advances toward the light-reflecting plate REF disposed under the backlight assembly to be reflected by the light-reflecting plate toward the conventional DBEF film. As a result, luminance is enhanced. The display unit includes an LCD panel LCDP, a bottom polarization plate BP disposed under the LCD panel LCDP, and a top polarization plate TP disposed over the LCD panel LCDP.

The above-described conventional DBEF includes more than 800 films accumulated to have a thickness of only hundreds of micrometers, so that a process of manufacturing the conventional DBEF is very complex, thereby increasing manufacturing cost.

On the contrary, a cholesteric liquid crystal film CLCF according to an exemplary embodiment of the present invention reflects left-handed circularly polarized light ‘L’ emitted by the lamp, and transmits right-handed circularly polarized light ‘R’. The transmitted right-handed circularly polarized light ‘R’ is transformed into a linearly polarized light ‘P’ by a phase shift layer PHL. The linearly polarized light is then applied to the display unit.

The cholesteric liquid crystal film CLCF has only a few layers, so that a process of manufacturing the cholesteric liquid crystal film CLCF is relatively simple. Furthermore, by forming the phase shift layer PHL on the cholesteric liquid crystal film CLCF, a reflective polarizing film may be formed, which was embodied by the conventional DBEF.

According to the present invention, a flat fluorescent lamp includes a reflective polarizing layer including the cholesteric liquid crystal film CLCF and the phase shift layer PHL disposed at the liquid crystal layer. The cholesteric liquid crystal film CLCF reflects one of the right-handed circularly polarized light R and the left-handed circularly polarized light L, and transmits the other one of the right-handed circularly polarized light R and the left-handed circularly polarized light L. A transmitted circularly polarized light is converted into a linearly polarized light by the phase shift layer PHL. Therefore, a luminance uniformity is enhanced. Furthermore, a number of parts for manufacturing the flat fluorescent lamp may be reduced to enhance productivity.

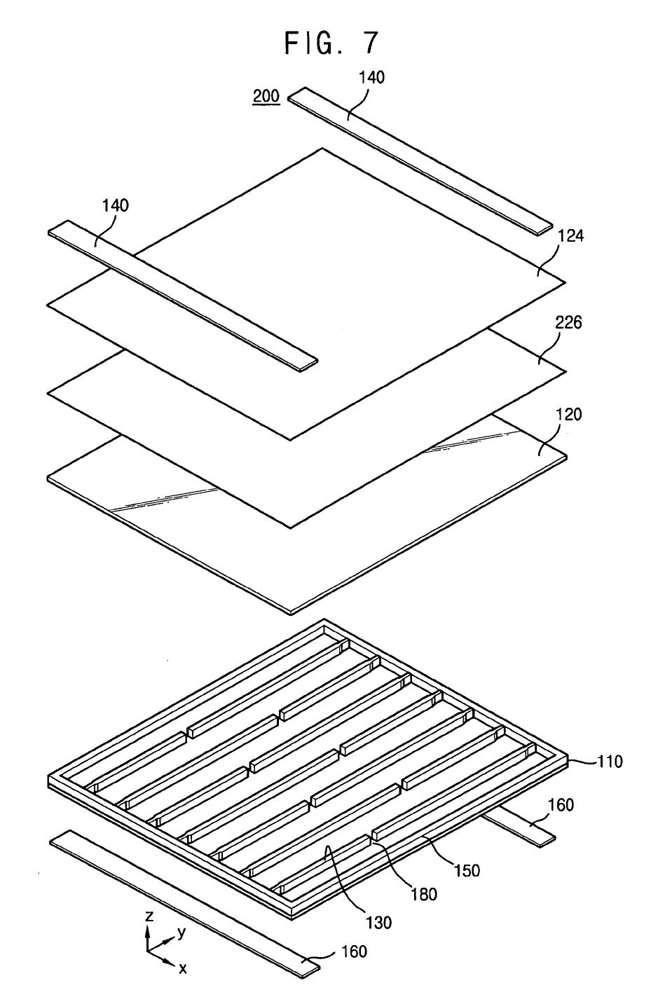

FIG. 7 is an exploded perspective view illustrating a flat fluorescent lamp according to another exemplary embodiment of the present invention.

Referring to FIG. 7, a flat fluorescent lamp 200 according to the present embodiment includes the rear substrate 110, the front substrate 120, the partition members 130 and the first external electrodes 140. The flat fluorescent lamp 200 of the present exemplary embodiment is same as the exemplary embodiment shown in FIG. 1 except a light-diffusing layer 226. Thus, the same reference numerals will be used to refer to the same or like parts as those described with reference to FIG. 1, and any further explanation concerning the above elements will be omitted.

The light-diffusing layer 226 is disposed between the front substrate 120 and the reflective polarizing layer (or reflective polarizing film) 124. In other words, the light-diffusing layer 226 is disposed at the front substrate 120, and the reflective polarizing layer (or reflective polarizing film) 124 is disposed at the light-diffusing layer 226. The reflective polarizing layer (or reflective polarizing film) 124 includes the cholesteric liquid crystal layer and the phase shift layer disposed at the cholesteric liquid crystal layer.

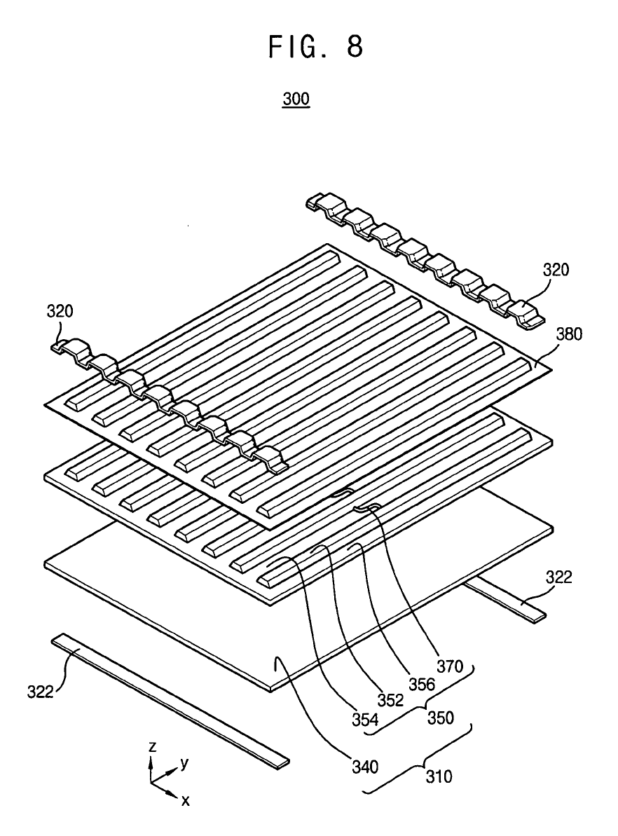

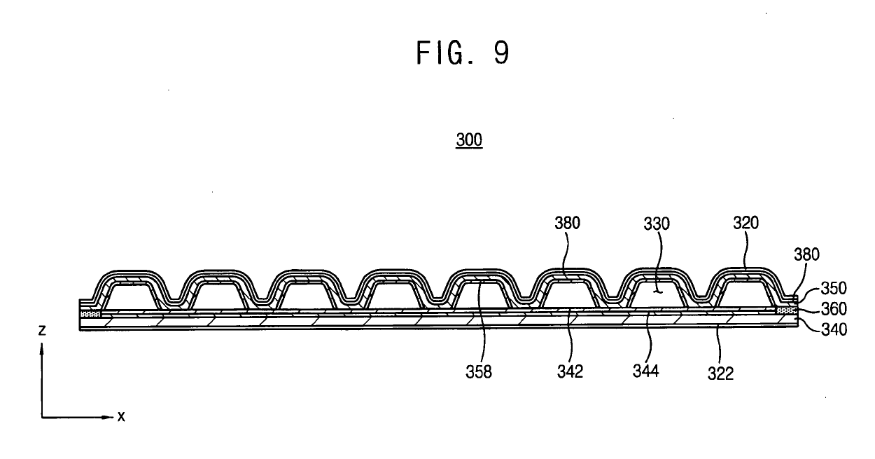

FIG. 8 is an exploded perspective view illustrating a flat fluorescent lamp according to still another exemplary embodiment of the present invention, and FIG. 9 is a cross-sectional view illustrating the flat fluorescent lamp in FIG. 8. The flat fluorescent lamp in FIGS. 8 and 9 includes a reflective polarizing film that is integrally formed therewith.

Referring to FIGS. 8 and 9, a flat fluorescent lamp 300 according to the present exemplary embodiment includes a lamp body 310 and first external electrodes 320. The lamp body 310 includes discharge spaces 330. The discharge spaces 330 are disposed substantially parallel to each other. The first external electrodes 320 are disposed on an outer surface of the lamp body 310. The first external electrodes 320 are disposed at first and second end portions of the lamp body 310. The first and second end portions are opposite to each other. A longitudinal direction of the first external electrodes 320 is substantially perpendicular to a longitudinal direction of the discharge spaces 330. The first external electrodes 320 overlap corresponding opposite end portions of the discharge spaces 330. In an alternative exemplary embodiment, the flat fluorescent lamp 300 includes second external electrodes 322. The second external electrodes 322 are disposed at an opposite outer surface of the lamp body with respect to the first external electrodes 320. The second external electrodes 322 are disposed corresponding to the first external electrodes 320 at the first and second end portions of the lamp body 310.

The lamp body 310 includes a rear substrate 340 and a front substrate 350. The rear and front substrates 340 and 350 are combined with each other to form the discharge spaces 330. The rear substrate 340 has, for example, a rectangular plate shape. A glass substrate that blocks ultraviolet light and transmits visible light may be employed as the rear and front substrates 340 and 350.

The front substrate 350 includes discharge space portions 352, space dividing portions 354 and a sealing portion 356. The discharge space portions 352 are spaced apart from the rear substrate 340, when the rear and front substrates 340 and 350 are combined with each other. Each of the space dividing portions 354 is disposed between the discharge space portions 352. In other words, each of the space dividing portions 354 is arranged alternately with each of the discharge space portions 352. The space dividing portions 354 make contact with the rear substrate 340, when the rear and front substrates 340 and 350 are combined with each other. The sealing portion 356 corresponds to edge portions of the front substrate 350. The rear and front substrates 340 and 350 are combined with an adhesive such as, for example, frit disposed at the sealing portion 356.

The front substrate 350 may be formed through, for example, a forming process. In an example of such a forming process, a flat substrate is heated and compressed by a mold to form the front substrate 350 having the discharge space portions 352, the space dividing portions 354 and the sealing portion 356. The front substrate 350 may also be formed by various other methods.

A cross-section of each of the discharge spaces 330 has, for example, a rounded trapezoidal shape. Alternatively, the cross-section of each of the discharge spaces 352 may have, for example, a semi-circular shape, a rectangular shape, etc.

A reflective polarizing layer 380 is formed on the front substrate 350. The reflective polarizing layer 380 includes the cholesteric liquid crystal layer and the phase shift layer. The cholesteric liquid crystal layer is disposed at the front substrate 350, and the phase shift layer is disposed at the cholesteric liquid crystal layer. The cholesteric liquid crystal layer reflects a light having a wavelength that is substantially equal to a spiral pitch times an average refractivity of an extraordinary refractivity and an ordinary refractivity of a cholesteric liquid crystal, and transmits a light having a different wavelength.

The phase shift layer disposed at the cholesteric liquid crystal layer polarizes light that passes through the cholesteric liquid crystal layer.

The front substrate 350 is combined with the rear substrate 340 through a sealing member 360 such as, for example, frit disposed at the sealing portion 356. The frit includes glass and metal such as lead (Pb), so that a melting point of the frit is lower than a melting point of glass. When the rear and front substrates 340 and 350 make contact with each other, while the frit is disposed between the rear and front substrates 340 and 350, the frit is heated to combine the rear and front substrates 340 and 350.

The sealing member 360 is not disposed at the space dividing portions 354. However, the space dividing portions 354 of the front substrate 350 make contact with the rear substrate 340 when the rear and front substrates 340 and 350 are combined with each other due to a pressure difference between the discharge spaces 330 and atmosphere.

For example, when the rear and front substrates 340 and 350 are combined with each other, air of the discharge space portions 352 is exhausted and then discharge gas is injected into the discharge space portions 352. Examples of the discharge gas include, for example, mercury (Hg), neon (Ne), argon (Ar), xenon (Xe), krypton (Kr), etc. A pressure of the discharge space 330 is about 50 torr, which is much less than an atmospheric pressure of about 760 torr, so that the space diving portions 354 make contact with the rear substrate 340 when the rear and front substrates 340 and 350 are combined with each other.

The front substrate 350 further includes connection paths 370. At least one of the connection paths 370 is formed at each of the space diving portions 354. The discharge gas injected into one of the discharge spaces 330 spreads out uniformly throughout the discharge spaces 330 via the connection paths 370.

As discussed above, the first external electrodes 320 are disposed at the outer surface of the front substrate 350. The first external electrodes 320 include a metal having good electrical conductivity such as, for example, copper (Cu), nickel (Ni), silver (Ag), gold (Au), aluminum (Al), chromium (Cr), etc. The first external electrodes 320 may be formed through a spray method. For example, metal powder is sprayed onto a portion of the front substrate 350 through a mask, and then the mask is removed leaving the first external electrodes 320 disposed at the first and second end portions of the lamp body 310. Alternatively, the first external electrodes 320 may be formed through aluminum tape, silver paste, etc. The first external electrodes 320 may include an optically transparent and electrically conductive material such as indium tin oxide (ITO), indium zinc oxide (IZO), etc. In response to a discharge voltage being applied to the first external electrodes 320, the discharge gas generates ultraviolet light.

The lamp body 310 further includes a first fluorescent layer 342, a light-reflecting layer 344 and a second fluorescent layer 358. The first and second fluorescent layers 342 and 358 are disposed at an inner surface of the rear and front substrates 340 and 350, respectively. The first and second fluorescent layers 342 and 358 convert the ultraviolet light generated by the discharge gas into visible light.

The light-reflecting layer 344 is disposed between the rear substrate 340 and the first fluorescent layer 342. The light-reflecting layer 344 reflects visible light advancing toward the light-reflecting layer 344 toward the front substrate 350.

The lamp body 310 may further include a protection layer (not shown). The protection layer is disposed between the front substrate 350 and the second fluorescent layer 358. The protection layer may be disposed between the rear substrate 340 and the light-reflecting layer 344. The protection layer prevents a chemical reaction between mercury in the discharge gas and the rear and front substrates 340 and 350, to prevent blackening of the rear and front substrates 340 and 350.

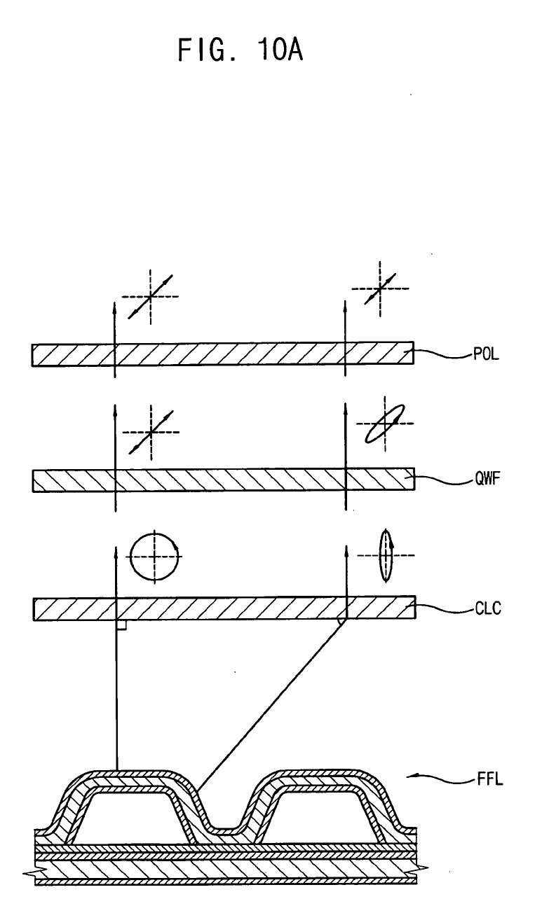

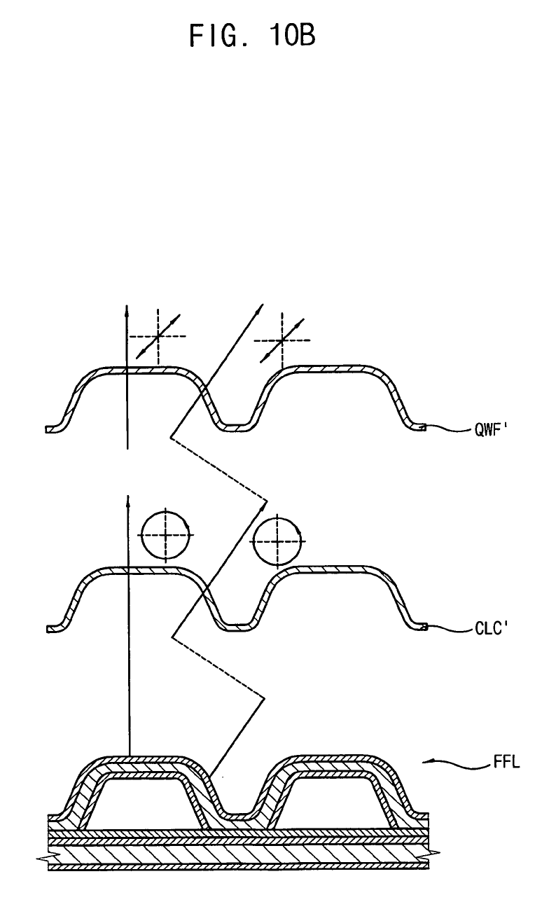

FIGS. 10A and 10B are conceptual views illustrating polarization steps of a first light that enters a reflective polarizing film having cholesteric liquid crystal at an angle perpendicular to a planar surface of a flat fluorescent lamp FFL and a second light that enters the reflective polarizing film having cholesteric liquid crystal in at an angle inclined with respect to the planar surface of the flat fluorescent lamp FFL. For example, FIG. 10A corresponds to a flat reflectively polarizing film, and FIG. 10B corresponds to a reflective polarizing film that is curved along a surface of the front substrate.

Referring to FIG. 10A, a reflective polarizing film includes a cholesteric liquid crystal film CLC, a quarter wave film QWF and a linearly polarizing film POL. The cholesteric liquid crystal film CLC includes many of cholesteric liquid crystal layers in order to cover all wavelengths of visible light. The quarter wave film QWF is disposed at the cholesteric liquid crystal film CLC and corresponds to a phase shift layer. The quarter wave film QWF converts a circularly polarized light into a linearly polarized light. The linearly polarizing film POL is disposed at the quarter wave film QWF. The linearly polarizing film has an optical axis that is tilted by about 45 degrees.

The first light that enters the reflective polarizing film at the angle perpendicular to the planar surface of the flat fluorescent lamp FFL is converted into a circularly polarized light. The circularly polarized light is converted into a linearly polarized light by the quarter wave film QWF, and the linearly polarized light passes through the linearly polarizing film POL.

The second light that enters the reflective polarizing film at the angle inclined with respect to the planar surface of the flat fluorescent lamp FFL is converted into an elliptically polarized light, since the cholesteric liquid crystal has a different refractive index with respect to direction. Even though the elliptically polarized light passes through the quarter waver film QWF, the elliptically polarized light is not converted into a linearly polarized light. However, the elliptically polarized light is converted into a linearly polarized light by the linearly polarizing film POL. However, intensity is reduced to cause a lower luminance.

Referring to FIG. 10B, a reflective polarizing film is curved along a surface of a front substrate of the flat fluorescent lamp FFL, so that a majority portion of light that exits the flat fluorescent lamp FFL enters the reflective polarizing film at the angle perpendicular to the planar surface of the flat fluorescent lamp FFL. The reflective polarizing film includes a quarter wave plate QWF′ and a cholesteric liquid crystal layer CLC′, which are each curved along the surface of the front substrate. In FIG. 10B, the flat fluorescent lamp FFL, the cholesteric liquid crystal layer CLC′ and the quarter wave plate QWF′ are described as if the flat fluorescent lamp FFL, the cholesteric liquid crystal layer CLC′ and the quarter wave plate QWF′ are spaced apart from each other. FIG. 10B is drawn as such only for convenience of description.

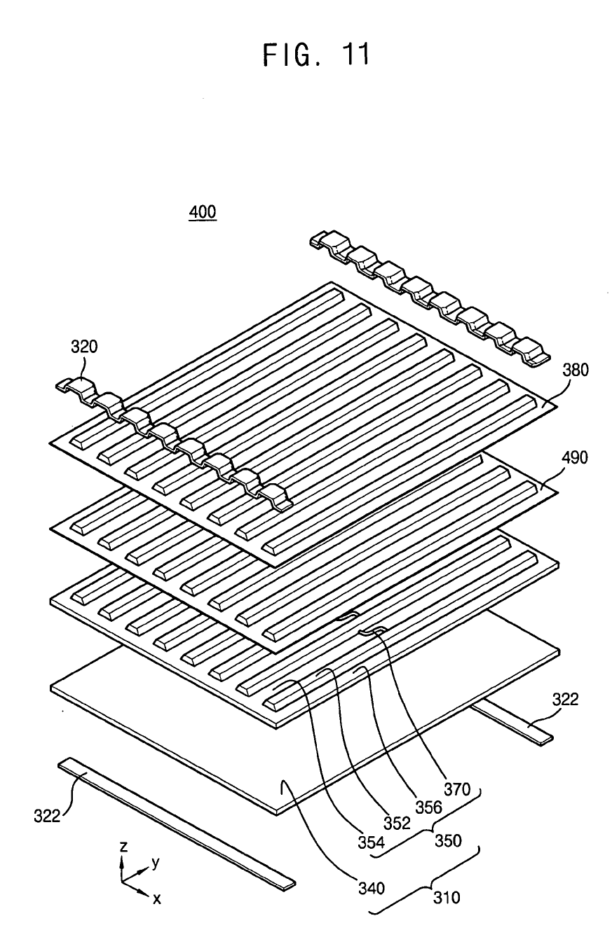

FIG. 11 is an exploded perspective view illustrating a flat fluorescent lamp according to still another exemplary embodiment of the present invention. The flat fluorescent lamp in FIG. 11 includes a reflective polarizing film that is integrally formed therewith.

Referring to FIG. 11, a flat fluorescent lamp 400 according to the present embodiment includes the lamp body 310 and the first external electrodes 320. The flat fluorescent lamp 400 of the present embodiment is same the exemplary embodiment shown in FIG. 8 except for an addition of a light-diffusing layer 490. Thus, the same reference numerals will be used to refer to the same or like parts as those described referring to FIG. 8, and any repetitive explanation concerning the above elements will be omitted.

The light-diffusing layer 490 is disposed at the front substrate 350, and the reflective polarizing layer 380 is disposed at the light-diffusing layer 490. The light-diffusing layer 490 diffuses light to reduce dark regions caused by the space dividing portions 354.

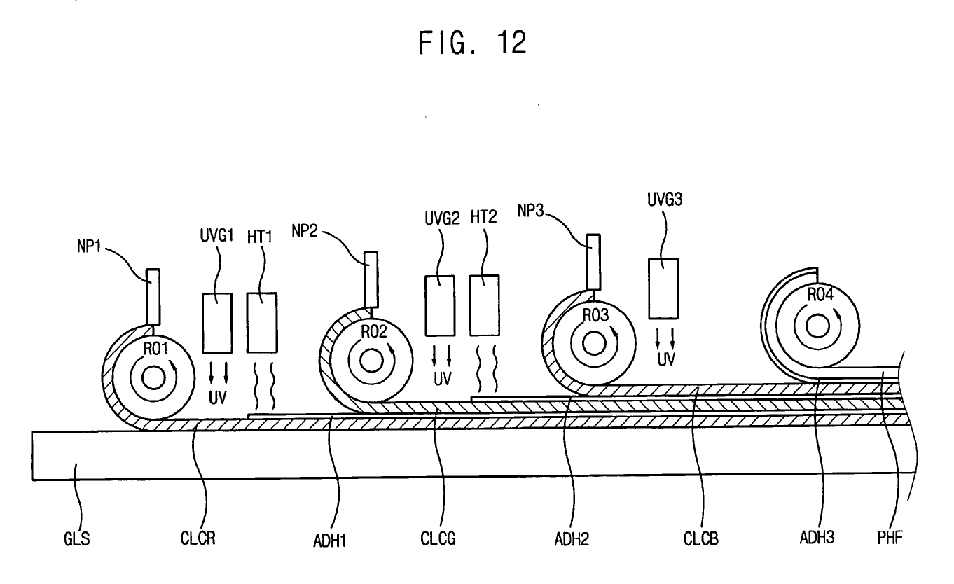

FIG. 12 is a cross-sectional view illustrating a method of manufacturing a reflective polarizing film.

Referring to FIG. 12, a first layer CLCR including cholesteric liquid crystal and VA liquid crystal is formed on a glass substrate GLS, for example, by a first roller RO1 and a first nipper NP1. The first layer CLCR includes a material having a mixture of a first ratio of the cholesteric liquid crystal to the VA liquid crystal. Then, ultraviolet light UV is irradiated onto the first layer CLCR to harden the first layer CLCR. The ultraviolet light UV is applied to the first layer CLCR by a first irradiation process UVG1. The first ratio of the cholesteric liquid crystal to the VA liquid crystal is about 8:2 in order for the first layer CLCR to reflect red light. The first layer CLCR includes Igacure® 184 that includes about 5 percent by weight of a UV-photochemical initiator, and about 50 percent by weight of a solvent such as toluene. When the Igacure® 184 is added to the solvent, the solvent is stirred, for example, by a magnetic stirring bar at a temperature of about 80° C. to about 90° C. for about 30 minutes to form the first layer CLCR.

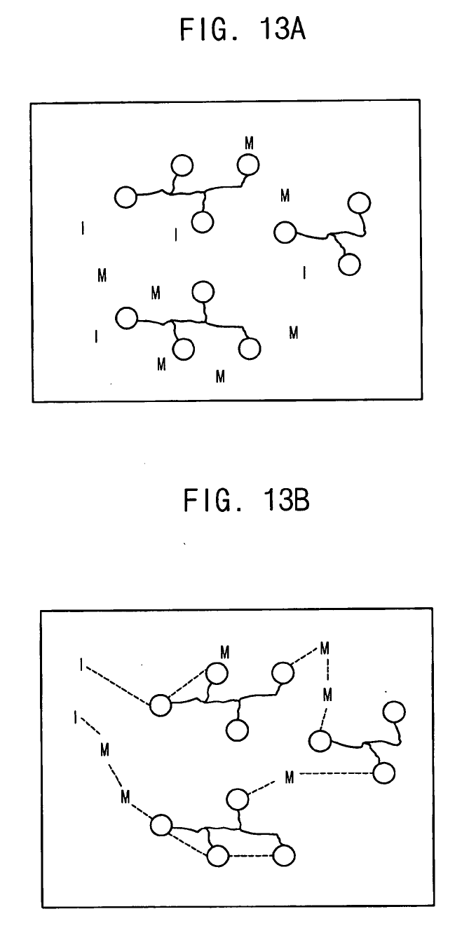

FIGS. 13A and 13B are conceptual views illustrating a UV photopolymerization mechanism.

Referring to FIG. 13A, a UV cross-link agent according to an exemplary embodiment the present invention includes a photopolymerization initiator ‘I’ and photo cross-link agent solvent. The cross-link agent solvent includes a photopolymerization monomer ‘M’ or a photopolymerization oligomer ‘O-O’. When UV light is irradiated onto the cross-link agent, the cross-link agent is hardened as shown in FIG. 13B, and refractivity and transmissivity may be adjusted.

The photopolymerization monomer ‘M’ or oligomer ‘O-O’ includes, for example, acrylate-based resin, epoxyacrylate-base resin, polyesteracrylate-based resin, urethaneacrylate-based resin, etc. The photopolymerization initiator ‘I’ includes, for example, acetophenone-based compound, benzophenone-based compound, thioxanthone-based compound, Igacure® series, etc. Preferably, a contraction ratio of a volume before hardening to a volume after hardening is less than about 20%.

Referring again to FIG. 12, when the first layer CLCR is hardened by UV light in a first irradiation process UVG1, a first adhesive layer ADH1 is disposed at the first layer CLCR. The first adhesive layer ADH1 is heated by a first heating process HT1. Then, a second layer CLCG including cholesteric liquid crystal and VA liquid crystal is disposed at the first adhesive layer ADH1, for example, by a second roller RO2 and a second nipper NP2. The second layer CLCG includes a material having a mixture of a second ratio of the cholesteric liquid crystal to the VA liquid crystal. Then, UV light is irradiated onto the second layer CLCG to harden the second layer CLCG in a second irradiation process UVG2. The second ratio of the cholesteric liquid crystal to the VA liquid crystal is about 7:3 in order for the second layer CLCG to reflect green light. The second layer CLCG includes Igacure® 184 that includes about 5 percent by weight of a UV photochemical initiator, and about 50 percent by weight of a solvent such as toluene. When the Igacure® 184 is added to the solvent, the solvent is stirred, for example, by a magnetic stirring bar at a temperature of about 80° C. to about 90° C. for about 30 minutes to form the second layer CLCG.

When the second layer CLCG is hardened by UV light, a second adhesive layer ADH2 is disposed at the second layer CLCG. The second adhesive layer ADH2 is heated by a second heating process HT2. Then, a third layer CLCB including cholesteric liquid crystal and VA liquid crystal is disposed at the second adhesive layer ADH2, for example, by a third roller RO3 and a third nipper NP3. The third layer CLCB includes a material having a mixture of a third ratio of the cholesteric liquid crystal to the VA liquid crystal. Then, UV light is irradiated onto the third layer CLCB to harden the third layer CLCB in a third irradiation process UVG3. The third ratio of the cholesteric liquid crystal to the VA liquid crystal is about 6:4 in order for the third layer CLCB to reflect blue light. The third layer CLCB includes Igacure® 184 that includes about 5 percent by weight of a UV-photochemical initiator, and about 50 percent by weight of a solvent such as toluene. When the Igacure® 184 is added to the solvent, the solvent is stirred, for example, by a magnetic stirring bar at a temperature of about 80° C. to about 90° C. for about 30 minutes to form the third layer CLCB.

When the third layer CLCB is hardened, a third adhesive layer ADH3 is disposed at the third layer CLCB, and a phase shift layer PHF is disposed at the third adhesive layer ADH3 by a fourth roller RO4.

Hereinbefore, the first, second and the third ratios are not fixed values. As long as the first, second and third layers, CLCR, CLCG and CLCG reflect red, green and blue lights, respectively, the first, second and third ratios may be varied. In other words, the first, second and third ratios may be adjusted such that the first, second and third layers, CLCR, CLCG and CLCG reflect red, green and blue lights, respectively. For example, the first ratio may be in a range from about 8.5:1.5 to about 7.5:2.5, the second ratio may be in a range from about 7.5:2.5 to about 6.5:3.5, and the third ratio may be in a range from about 6.5:3.5 to about 5.5:4.5, respectively.

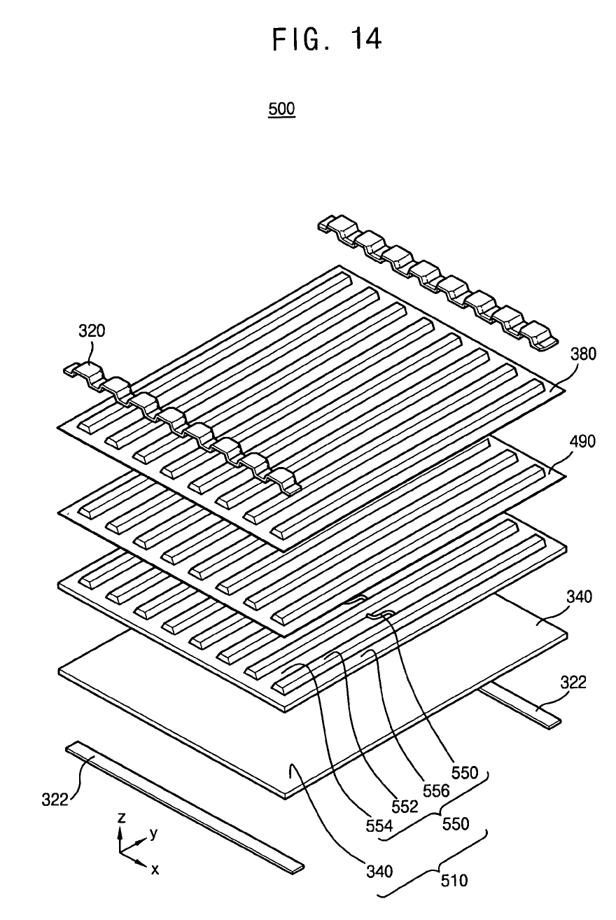

FIG. 14 is an exploded perspective view illustrating a flat fluorescent lamp according to still another exemplary embodiment of the present invention.

Referring to FIG. 14, a flat fluorescent lamp 500 according to the present exemplary embodiment includes a lamp body 510 and the first external electrodes 320. The flat fluorescent lamp 500 of the present exemplary embodiment is same as the exemplary embodiment shown in FIG. 11 except a front substrate 550. Thus, the same reference numerals will be used to refer to the same or like parts as those described with reference to FIG. 11, and any repetitive explanation concerning the above elements may be omitted.

The lamp body 510 includes the rear substrate 340 and the front substrate 550. The front substrate 550 includes discharge space portions 552, space dividing portions 554 and a sealing portion 556. The discharge space portions 552 are spaced apart from the rear substrate 340, when the rear and front substrates 340 and 550 are combined with each other. Each of the space dividing portions 554 is disposed between the discharge space portions 552. In other words, the space dividing portions 554 are disposed alternately with the discharge space portions 552. The space dividing portions 554 make contact with the rear substrate 340, when the rear and front substrates 340 and 550 are combined with each other. The sealing portion 556 corresponds to edge portions of the front substrate 550. The rear and front substrates 340 and 550 are combined by an adhesive such as frit disposed at the sealing portion 556.

The front substrate 550 includes a light-diffusing material, so that the front substrate 550 diffuses light. The front substrate 550 may be formed through, for example, a forming process. For example, a flat substrate is heated and compressed by a mold to form the front substrate 550 having the discharge space portions 552, the space dividing portions 554 and the sealing portion 556. The front substrate 550 may be formed by various alternative methods. The front substrate 550 further includes connection paths 570. At least one of the connection paths 570 is formed at each of the space diving portions 554. The connection paths 570 allow for a movement of discharge gas between adjacent discharge space portions 552.

The light-diffusing layer 490 is disposed at an outer surface of the front substrate 550 including the light-diffusing material, and the reflective polarization layer 380 is disposed at the light-diffusing layer 490. The light-diffusing layer 490 further diffuses light diffused by the front substrate 550. The light-diffusing layer 490 and the reflective polarizing layer 380 are disposed at the lamp body 510. Alternatively, the light-diffusing layer 490 and the reflective polarizing layer 380 may be formed in a film as a light-diffusing film and a reflective polarizing film, respectively, and the light-diffusing film and the reflective polarizing film may be disposed over the lamp body 510.

The reflective polarizing layer 380 is disposed at the front substrate 550. The reflective polarizing layer 380 includes the cholesteric liquid crystal layer and the phase shift layer. The cholesteric liquid crystal layer is disposed at the front substrate 350, and the phase shift layer is disposed at the cholesteric liquid crystal layer. The cholesteric liquid crystal layer reflects light having a wavelength that is substantially equal to a spiral pitch multiplied by an average refractivity of an extraordinary refractivity nₑ and an ordinary refractivity nₒ of a cholesteric liquid crystal, and transmits light having a different wavelength. The phase shift layer disposed at the cholesteric liquid crystal layer polarizes light that passes through the cholesteric liquid crystal layer.

The light-diffusing material is uniformly spread throughout the front substrate 550. Alternatively, an amount of the light-diffusing material in the discharge space portions 552 may be larger than an amount of the light-diffusing material in the space dividing portions 554 in order to uniformize luminance.

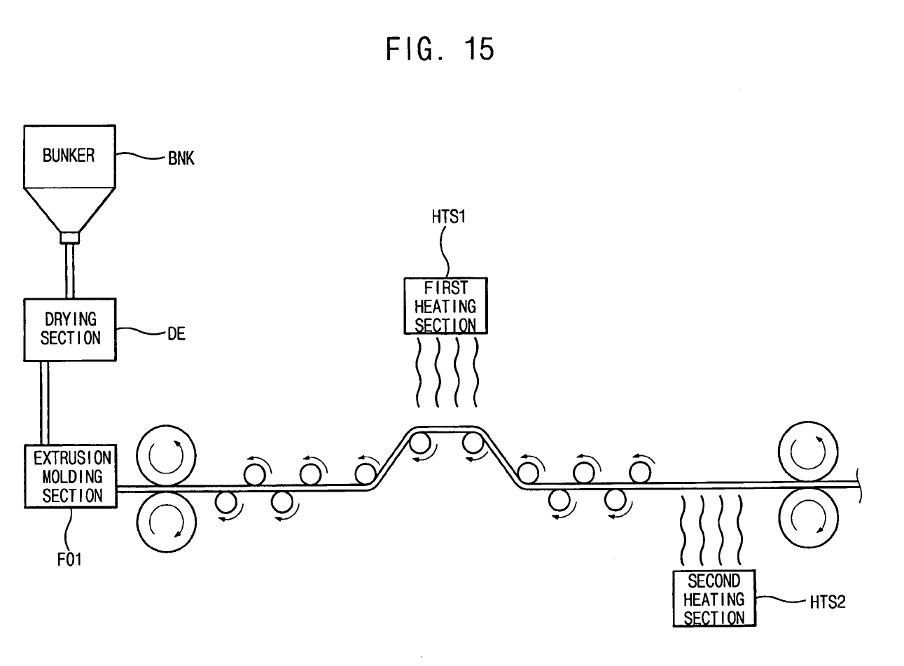

FIG. 15 is a schematic view illustrating a method of manufacturing a flat fluorescent lamp having a reflective polarizing film integrally formed therewith. In particular, FIG. 15 illustrates a method of manufacturing the front substrate having polycarbonate resin for diffusing light.

Referring to FIG. 15, a material such as silicon dioxide (SiO₂) that is used for glass is contained in a bunker BNK, and the material is dried by a drying section DE and applied to an extrusion molding section F01. The extrusion molding section F01 extrudes the material to have a uniform thickness. The extruded material passes through cooling rollers, a first heating section HTS1, and a second heating section HTS2, so that the front substrate is formed.

In detail, the material, for example, silicon dioxide having a temperature in a range of about 300° C. to about 330° C. (alternatively, from about Tg to about Tg+180° C., wherein Tg corresponds to a glass transition temperature) is extruded by the extrusion molding section F01. The material passes through the cooling roller having a temperature of about 100° C. to about 140° C. In order to compensate a shear stress of extrusion molding with a contraction ratio of glass while the material cools down, a thickness of the extruded material is adjusted to be about 34 μm. The material may include inorganic light-diffusing material such as, for example, aluminum oxide (Al₂O₃), Talc (Si, Mg), silicon, calcium carbonate (CaCO3), etc. and a mixture thereof by an amount of about 0.01% to about 40% in order to enhance a light diffusing function.

Hereinafter, experimental results will be explained. In an experiment, a backlight assembly used for a display panel having about 13.3 inches was used in both comparative and experimental examples. A dual brightness enhancement-film diffuser (DBEF-D) manufactured by 3M Company was used for the comparative example and the reflective polarization film shown in FIGS. 8 and 11 was used for the experimental examples. In order to measure luminance, an apparatus named BM-7 I manufactured by TOPCON Company was used. Results of the comparative example and the experimental examples are shown in Table 1 below.

A backlight assembly employing the flat fluorescent lamp 300 shown in FIG. 8 includes the reflective polarizing layer 380 disposed at the lamp body 310, and a backlight assembly employing the flat fluorescent lamp 400 shown in FIG. 11 includes a the light-diffusing layer 490 disposed at the lamp body 310 and the reflective polarizing layer 380 disposed at the light-diffusing layer 490.

TABLE 1

| | Comparative | Embodiment of | Embodiment of |
|---|---|---|---|
| Point | Example | | |
| Averaged luminance | 106 | 130 | 145 |
| measured at 13 points | | | |
| Averaged luminance | 109 | 134 | 150 |
| measured at 5 points | | | |
| Wx | 0.3136 | 0.3183 | 0.3197 |
| Wy | 0.3467 | 0.3550 | 0.3679 |
| Luminance uniformity | 69.7% | 73.1% | 75.9% |
| Luminance comparison | 7.0% | 8.6% | 8.8% |
| of 13 points | | | |
| Luminance comparison | 7.2% | 8.8% | 9.1% |
| of 5 points | | | |
| Luminance efficiency of | | 123% | 126% |
| 13 points | | | |
| Luminance efficiency of | | 122% | 126% |
| 5 points | | | |

As shown in Table 1, a CIE color coordinate x-axis value and a CIE color coordinate y-axis value of the exemplary embodiments shown in FIGS. 8 and 11 are within a critical range of the comparative example.

According to luminance measured at 13 points and 5 points, the exemplary embodiments shown in FIGS. 8 and 11 show a higher luminance than the comparative example. Furthermore, luminance uniformity of the exemplary embodiments shown in FIGS. 8 and 11 is also better than luminance uniformity of the comparative example.

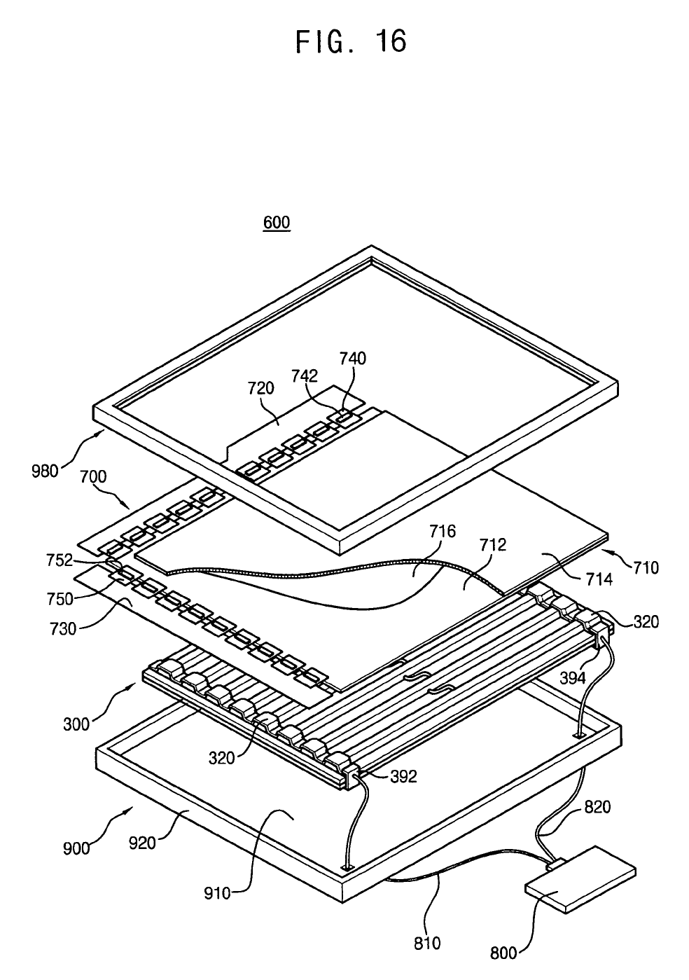

FIG. 16 is an exploded perspective view illustrating a liquid crystal display device according to an exemplary embodiment of the present invention.

Referring to FIG. 16, a liquid crystal display (LCD) device 600 includes the flat fluorescent lamp 300, a display unit 700 and an inverter 800. Alternatively, any one of the flat fluorescent lamps described in above-mentioned exemplary embodiments may be employed as the flat fluorescent lamp 300.

The display unit 700 includes an LCD panel 710, a data driving printed circuit board (or a data driving PCB) 720, and a gate driving printed circuit board (or a gate PCB) 730. The data and gate PCBs 720 and 730 provide the LCD panel 710 with driving signals. The data and gate PCBs 720 and 730 are connected to the LCD panel 710 via a data tape carrier package (or a data TCP) 740 and a gate tape carrier package (or gate TCP) 750, respectively. The data and gate TCPs 740 and 750 include a data driver chip 742 and a gate driver chip 752, respectively. The data driver chip 742 and the gate driver chip 752 receive driving signals provided from the data and gate PCBs 720 and 730 and provide the LCD panel 710 with the driving signals at a proper time.

The LCD panel 710 includes a thin film transistor (TFT) substrate 712, a color filter substrate 714 and a liquid crystal layer 716. The TFT substrate 712 and the color filter substrate 714 face each other. The liquid crystal layer 716 is disposed between the TFT substrate 712 and the color filter substrate 714.

The TFT substrate 712 includes a plurality of TFTs (not shown) arranged in a matrix shape. Each of the TFTs includes a gate electrode that is electrically connected to one of gate lines, a source electrode that is electrically connected to one of source lines and a drain electrode that is electrically connected to a pixel electrode (not shown). The pixel electrode includes an optically transparent and electrically conductive material such as indium tin oxide (ITO), indium zinc oxide (IZO), etc.

The color filter substrate 714 includes a color filter layer (not shown) and a common electrode (not shown). The color filter layer includes red color filters, green color filters and blue color filters. The common electrode is disposed at the color filter layer and includes an optically transparent and electrically conductive material such as indium tin oxide (ITO), indium zinc oxide (IZO), etc. A reference voltage is applied to the common electrode.

When a gate signal (or a scan signal) is applied to a TFT through one of the gate lines, the TFT is turned on so that a source signal (or data signal) applied to one of the source lines is applied to the pixel electrode. As a result, electric fields are generated between the pixel electrode and the common electrode to alter an arrangement of liquid crystal molecules of the liquid crystal layer 716, so that optical transmissivity is changed to display images.

The inverter 800 generates a discharge voltage for driving the flat fluorescent lamp 300. The inverter 800 receives an alternating current, and boosts the alternating current to generate the discharge voltage. The discharge voltage generated by the inverter 800 is applied to the first external electrodes 320 of the flat fluorescent lamp 300 through a first wire 810 and a second wire 820. The discharge voltage is also applied to the second external electrodes 322, when the flat fluorescent lamp 300 further includes the second external electrodes 322. When the flat fluorescent lamp 300 further includes the second external electrodes 322, the flat fluorescent lamp 300 further includes a first conductor clip 392 and a second conductor clip 394. The first and second conducting clips 392 and 394 electrically connect the first and second external electrodes 320 and 322. The first and second conducting clips 392 and 394 are electrically connected to the first and second wires 810 and 820, respectively.

The LCD device 600 further includes a receiving container 900 for receiving the flat fluorescent lamp 300, and a fixing member 980 for fixing the LCD panel 710.

The receiving container 900 includes a bottom plate 910 and sidewalls 920. The bottom plate 910 supports the flat fluorescent lamp 300. The sidewalls 920 are extended from edge portions of the bottom plate 910. The receiving container 900 optionally includes an insulating member (not shown) that electrically insulates the flat fluorescent lamp 300 from the receiving container 900.

The fixing member 980 surrounds edge portions of the LCD panel 710, and is combined with the receiving container 900 to fasten the LCD panel 710 to the receiving container 900. The fixing member 980 protects the LCD panel 710 and prevents drifting of the LCD panel 710.

According to the present invention, luminance uniformity is enhanced. Furthermore, functions of a light-diffusing plate, a reflective polarizing film and a prism sheet are integrated into a reflective polarizing layer. Therefore, productivity is enhanced.

Having described exemplary embodiments of the present invention and its advantages, it is noted that various changes, substitutions and alterations can be made herein without departing from the spirit and scope of the invention as defined by the appended claims.

1-32. (canceled)

33. An optical film comprising:
liquid crystal layers disposed at a base substrate, each of the liquid crystal layers reflecting light having a first wavelength and transmitting light having a wavelength different from the first wavelength; and
adhesive layers, each of the adhesive layers being disposed between adjacent ones of the liquid crystal layers to combine the liquid crystal layers.

34. The optical film of claim 33, wherein the first wavelength is defined by an expression λ=P×(nₒ+nₑ)/2, wherein ‘λ’ represents the first wavelength, ‘P’ represents a spiral pitch that corresponds to a spatial period of periodically arranged liquid crystal molecules of each of the liquid crystal layers, and nₒ and nₑ represent an ordinary refractivity and an extraordinary refractivity of each of the liquid crystal layers, respectively.

35. The optical film of claim 34, wherein the spiral pitch corresponds a distance from cholesteric liquid crystal molecules having substantially a same alignment with respect to an axis that is substantially perpendicular to the base substrate.

36. The optical film of claim 33, wherein each of the liquid crystal layers comprises cholesteric liquid crystal, and cholesteric liquid crystal molecules of each of the liquid crystal layers are disposed at positions gradually rotated with respect to each other about an axis that is substantially perpendicular to the base substrate to form a spiral shape.

37. The optical film of claim 33, further comprising a phase shift layer disposed at a top liquid crystal layer to convert light that exits the top liquid crystal layer into a linearly polarized light.

38. The optical film of claim 37, wherein the top liquid crystal layer has a thickness of about 20 cm, and the phase shift layer has a thickness of about 50 m.

39. The optical film of claim 33, wherein each of the liquid crystal layers comprises:
a first liquid crystal layer disposed at the base substrate, the first liquid crystal layer reflecting light having a second wavelength;
a second liquid crystal layer disposed proximate to the first liquid crystal layer, the second liquid crystal layer reflecting light from the first liquid layer having a third wavelength; and
a third liquid crystal layer disposed proximate to the second liquid crystal layer, the third liquid crystal layer reflecting light from the second liquid crystal layer having a fourth wavelength.

40. The optical film of claim 39, wherein the second wavelength is greater than the third wavelength, and the third wavelength is greater than the fourth wavelength.

41. The optical film of claim 40, wherein the second, third and fourth wavelengths correspond to wavelengths of red light, green light and blue light, respectively.

42. The optical film of claim 33, wherein a thickness of each of the adhesive layers is less than a thickness of each of the liquid crystal layers.

43. The optical film of claim 33, wherein a ratio of a thickness of each of the liquid crystal layers to a thickness of each of the adhesive layers is within a range from about 4.5:1 to about 3.5:2.

44. The optical film of claim 33, wherein the base substrate is a polyester filament film (PEF).

45. The optical film of claim 33, wherein the base substrate is a glass substrate.

46. A method of manufacturing an optical film, comprising:
disposing a first liquid crystal layer at a base substrate, the first liquid crystal layer including a cholesteric liquid crystal and a vertical alignment liquid crystal mixed in a first ratio, the first liquid crystal layer reflecting light having a first wavelength and transmitting light having a wavelength different from the first wavelength;
disposing a second liquid crystal layer proximate to the first liquid crystal layer, the second liquid crystal layer including the cholesteric liquid crystal and the vertical alignment liquid crystal mixed in a second ratio, the second liquid crystal layer reflecting light having a second wavelength and transmitting light having a wavelength different from the second wavelength;
disposing a third liquid crystal layer proximate to the second liquid crystal layer, the third liquid crystal layer including the cholesteric liquid crystal and the vertical alignment liquid crystal mixed in a third ratio, the third liquid crystal layer reflecting light having a third wavelength and transmitting light having a wavelength different from the third wavelength; and
disposing a phase shift layer proximate to the third liquid crystal layer.

47. The method of claim 46, wherein the first, second and third wavelengths correspond to a wavelength of red light, green light and blue light, respectively.

48. The method of claim 46, wherein each of the first, second and third liquid crystal layers further comprises about 5 percent by weight of an ultraviolet photochemical initiator.

49. The method of claim 48, wherein each of the first, second and third liquid crystal layers is formed by:
coating a liquid crystal layer solution including about 50 percent by weight of a solvent; and
irradiating ultraviolet light onto the liquid crystal layer solution to dry the liquid crystal layer solution.

50. The method of claim 49, wherein the solvent is toluene.

51. The method of claim 46, wherein the first ratio is in a range from about 8.5:1.5 to about 7.5:2.5.

52. The method of claim 46, wherein the second ratio is in a range about 7.5:2.5 to about 6.5:3.5.

53. The method of claim 46, wherein the third ratio is in a range from about 6.5:3.5 to about 5.5:4.5.

54. The method of claim 46, wherein the phase shift layer corresponds to a quarter wave plate.

55. The method of claim 46, further comprising disposing a first adhesive layer at the first liquid crystal layer.

56. The method of claim 46, further comprising disposing a second adhesive layer at the second liquid crystal layer.

57. A flat fluorescent lamp comprising:
a lamp body including discharge spaces arranged parallel to each other and extended along a first direction;
electrodes disposed at opposite ends of an outer surface of the lamp body, each of the electrodes being extended along a second direction that is substantially perpendicular to the first direction; and
a reflective polarizing layer disposed at the lamp body, the reflective polarizing layer reflecting a first portion of light generated by the lamp body and transmitting a second portion of light generated by the lamp body.

58. The flat fluorescent lamp of claim 57, wherein the reflective polarizing layer comprises:
a cholesteric liquid crystal layer that reflects light having a first wavelength and transmits light having a wavelength different from the first wavelength, wherein the first wavelength is defined by an expression λ=P×(nₒ+nₑ)/2, wherein ‘λ’ represents the first wavelength, ‘P’ represents a spiral pitch that corresponds to a spatial period of periodically arranged liquid crystal molecules of each of the liquid crystal layers, and nₒ and nₑ represent an ordinary refractivity and an extraordinary refractivity of each of the liquid crystal layers, respectively; and
a phase shift layer disposed proximate to the cholesteric liquid crystal layer, the phase shift layer transforming light that passes through the cholesteric liquid crystal layer into a linearly polarized light.

59. The flat fluorescent lamp of claim 58, wherein the cholesteric liquid crystal layer comprises cholesteric liquid crystal molecules disposed at positions gradually rotated with respect to each other about an axis that is substantially perpendicular to the lamp body to form a spiral shape.

60. The flat fluorescent lamp of claim 58, wherein cholesteric liquid crystal molecules of the cholesteric liquid crystal layer are disposed at positions gradually rotated with respect to each other about an axis that is substantially perpendicular to a base substrate to form a spiral shape.

61. The flat fluorescent lamp of claim 58, wherein light that enters the cholesteric liquid crystal layer is converted into one of a right-handed circularly polarized light and a left-handed circularly polarized light according to a rotational direction of cholesteric liquid crystal molecules.

62. The flat fluorescent lamp of claim 58, further comprising a light-diffusing layer disposed between the lamp body and the cholesteric liquid crystal layer.

63. The flat fluorescent lamp of claim 57, wherein the lamp body comprises:
a rear substrate;
a front substrate facing the rear substrate; and
a partition member disposed between the rear and front substrates to divide a space between the rear and front substrates into discharge spaces, the reflective polarizing layer being disposed at the front substrate.

64. The flat fluorescent lamp of claim 63, wherein the lamp body further comprises:
a light-reflecting layer disposed at an inner surface of the rear substrate to reflect visible light toward the front substrate; and
a fluorescent layer disposed at the light-reflecting layer and an inner surface of the front substrate to convert invisible light generated by discharge gas in the discharge spaces into visible light.

65. The flat fluorescent lamp of claim 57, wherein the lamp body comprises:
a rear substrate; and
a front substrate combined with the rear substrate, the front substrate including discharge space portions that are spaced apart from the rear substrate to define discharge spaces, and space dividing portions, each of the space dividing portions being disposed between the discharge space portions adjacent to each other, the space dividing portions making contact with the rear substrate.

66. The flat fluorescent lamp of claim 65, wherein the lamp body further comprises:
a light-reflecting layer disposed at an inner surface of the rear substrate to reflect visible light toward the front substrate; and
a fluorescent layer disposed at the light-reflecting layer and an inner surface of the front substrate to convert invisible light generated by discharge gas in the discharge spaces into visible light.

67. The flat fluorescent lamp of claim 65, wherein the reflective polarizing layer is disposed at the front substrate.

68. The flat fluorescent lamp of claim 57, further comprising a light-diffusing part disposed between the lamp body and the reflective polarizing layer.

69. The flat fluorescent lamp of claim 68, wherein the light-diffusing part comprises a material including at least one of polycarbonate resin, polysulfone resin, polymethylmetharylateacrylate resin, polystyrene resin, polyvinylchloride resin, polyvinylalcohol resin, and polynorbonen resin.

70. A flat fluorescent lamp comprising:
a lamp body including discharge spaces arranged parallel to each other and extended along a first direction, the lamp body emitting light generated by discharge gas disposed in the discharge spaces through a light-exiting surface of the lamp body, the light-exiting surface including a light-diffusing material in order to diffuse light; and
external electrodes disposed at an outer surface of the lamp body and extended along a second direction that is substantially perpendicular to the first direction.

71. The flat fluorescent lamp of claim 70, further comprising a light converting part that converts light into a linearly polarized light.

72. The flat fluorescent lamp of claim 71, wherein the light converting part includes a phase shift layer.

73. The flat fluorescent lamp of claim 70, wherein the light-diffusing material includes at least one of aluminum oxide (Al₂O₃), Talc (Si, Mg), silicon, and calcium carbonate (CaCO3).

74. The flat fluorescent lamp of claim 70, wherein the light-exiting surface comprises the light-diffusing material by an amount of about 0.01% to about 40%.

75. A display device comprising:
a flat fluorescent lamp including:
a lamp body including discharge spaces arranged parallel to each other and extended along a first direction;
first electrodes disposed at opposite ends of a first outer surface of the lamp body, each of the first electrodes being extended along a second direction that is substantially perpendicular to the first direction; and
a reflective polarizing layer disposed on the lamp body, the reflective polarizing layer reflecting a first portion of light generated by the lamp body and transmitting a second portion of light generated by the lamp body; and
a display panel that displays images using the second portion of light.

76. The display device of claim 75, wherein the reflective polarizing layer comprises:
a cholesteric liquid crystal layer that reflects light having a first wavelength and transmits light having a wavelength different from the first wavelength, wherein the first wavelength is defined by an expression λ=P×(nₒ+nₑ)/2, wherein ‘λ’ represents the first wavelength of light, ‘P’ represents a spiral pitch that corresponds to a spatial period of periodically arranged liquid crystal molecules of each of the liquid crystal layers, and nₒ and nₑ represent an ordinary refractivity and an extraordinary refractivity of each of the liquid crystal layers, respectively; and
a phase shift layer disposed proximate to the cholesteric liquid crystal layer, the phase shift layer transforming light that passes through the cholesteric liquid crystal layer into a linearly polarized light.

77. The display device of claim 76, further comprising a power supplying part that provides the flat fluorescent lamp with power.

78. The display device of claim 76, further comprising second electrodes disposed at a second outer surface of the lamp body, the second outer surface being opposite to the first outer surface.
